(19) United States
(12) Patent Application Publication
(10) Pub. No.: US 2012/0218758 A1
(43) Pub. Date: Aug. 30, 2012

(54) ILLUMINATION DEVICE

(75) Inventors: HUA WANG, Shenzhen City (CN); GUANG YU, Shenzhen City (CN)

(73) Assignees: FOXCONN TECHNOLOGY CO., LTD., Tu-Cheng (TW); FU ZHUN PRECISION INDUSTRY (SHEN ZHEN) CO., LTD., Shenzhen City (CN)

(21) Appl. No.: 13/275,328

(22) Filed: Oct. 18, 2011

(30) Foreign Application Priority Data
Feb. 28, 2011 (CN) 201110047649.5

(51) Int. Cl. F21V 5/04; F21V 29/00; F21V 21/00

(52) U.S. Cl. 362/244; 362/249.02

(57) ABSTRACT

An illumination device includes a base, a plurality of light source modules and a power module. The base includes a first connection portion and a second connection portion. The first connection portion is configured for mounting a supporting structure. Each of the light source modules includes a main plate and a lamp. The lamp is mounted on a mounting plate of the main plate. The lamp includes a plurality of light emitting diodes. A connection block is defined on an opposite surface of the mounting plate. The power module is electrically coupled to the light emitting diodes of the lamp. The connection block of each of the light source modules is fixed to the second connection portion of the base after the connection block is slid on the second connection portion to reach a predetermined position.

### BACKGROUND

1. Technical Field

The disclosure relates to illumination devices, and more particularly to an illumination device utilizing a number of light emitting diodes.

2. Description of the Related Art

An illumination device with high luminance is very bulky and hard to maintain. Therefore, there is a need for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is an isometric view of an illumination device in accordance with one embodiment of the disclosure.

FIG. 2 is an isometric view of the illumination device in FIG. 1 mounted on a supporting structure.

FIG. 3 is an exploded view of the illumination device in FIG. 1.

FIG. 4 is an exploded view of a light source module of the illumination device in FIG. 1.

FIG. 5 is a bottom view of a main plate of the light source module of FIG. 4, showing distribution of heat dissipation pins thereof.

### DETAILED DESCRIPTION

The disclosure is illustrated by way of example and not by way of limitation in the figures of the accompanying drawings. It should be noted that references to “an” or “one” embodiment in this disclosure are not necessarily to the same embodiment, and such references mean at least one.

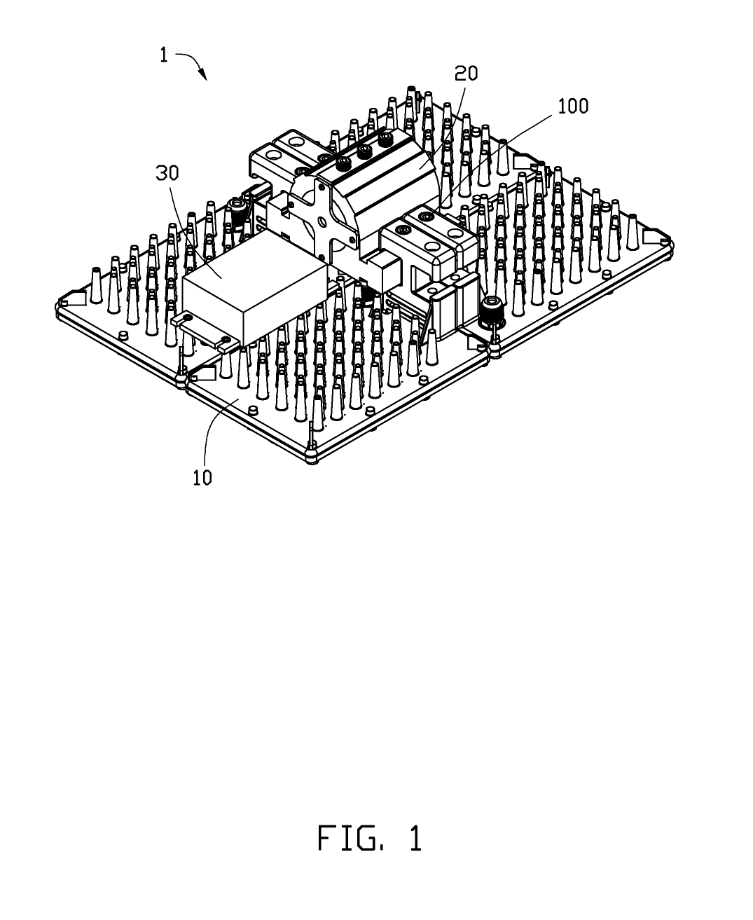

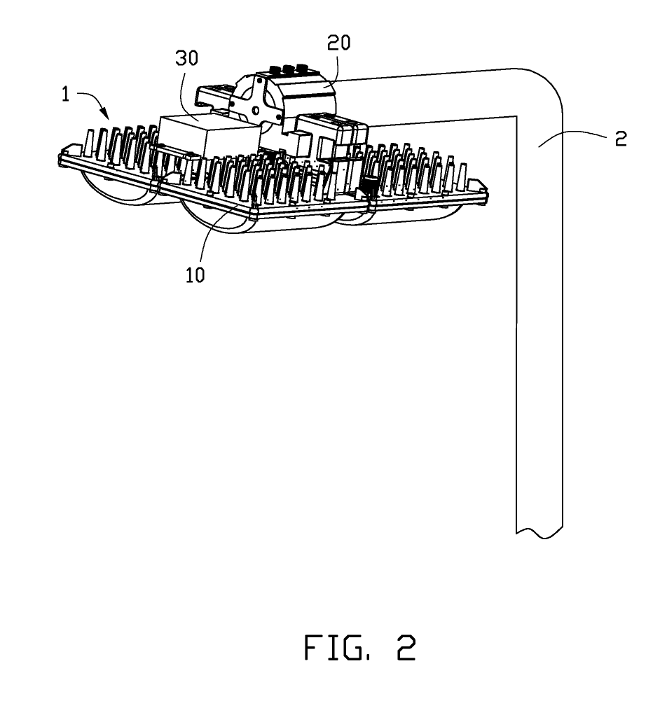

Referring to FIGS. 1-2, an illumination device 1 includes a light source module 10, a base 20 and a power module 30.

The light source module 10 is mounted on the base 20 with a number of screws 100. The base 20 is mounted on a support structure 2. The power module 30 provides electrical power and is mounted on the light source module 10. The power module 30 can be an adapter or a rechargeable battery.

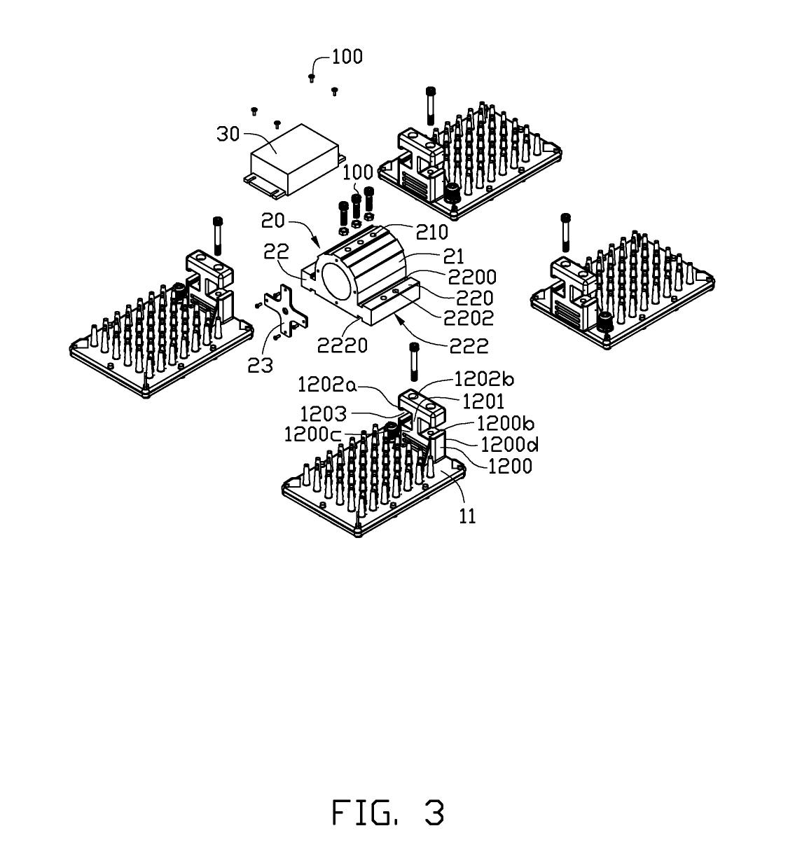

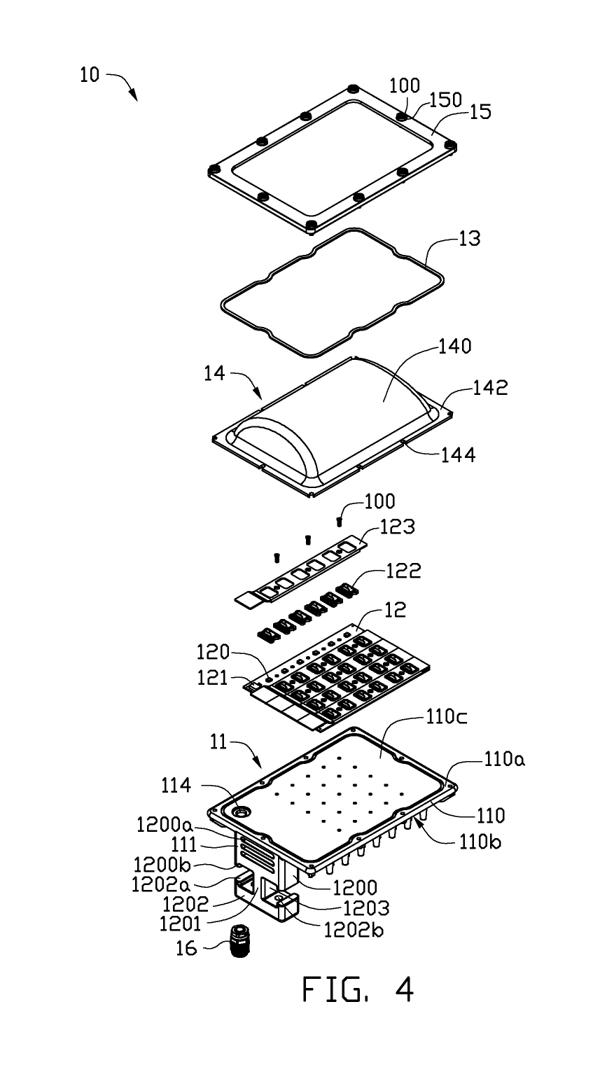

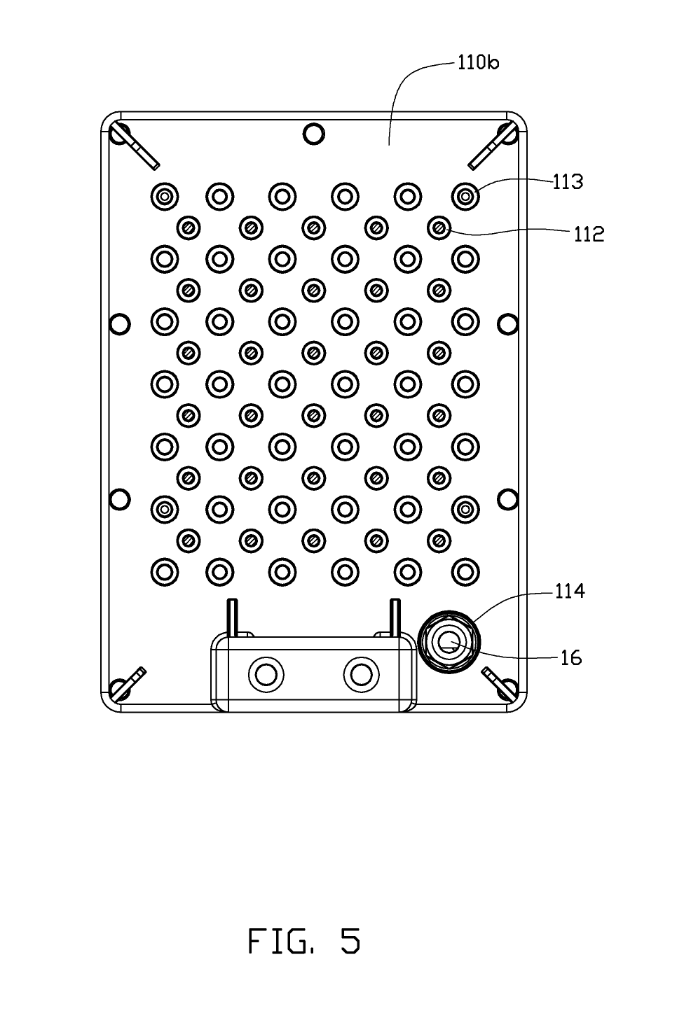

Referring to FIGS. 3-5, the light source module 10 includes a main plate 11, a lamp 12, a sealing ring 13, a cover 14, a fixture frame 15 and a waterproof screw 16.

The main plate 11 is made of high heat conductivity material. The main plate 11 includes a mounting plate 110 and a connection block 111. The mounting plate 110 is rectangular. The mounting plate 110 includes a mounting surface 110a and a heat dissipation surface 110b. The connection block 111 is defined on one side of heat dissipation surface 110b of the mounting plate 110. The connection block 111 includes a main base 1200, a support portion 1201 and a connection portion 1202. Two first protrusions 1200b are defined on the two sides of main base 1200. Two second protrusions 1202a are defined on the two sides of the connection portion 1202. Each of the first protrusions 1200b faces each second protrusion 1202a. A number of position holes 1202b are defined in the connection portion 1202.

A receiving portion 110c is defined in the mounting surface 110a. A number of lamps 12 are mounted on the receiving portion 110c with screws 100. Each of the lamps 12 includes a number of light emitting diodes 120 and a drive module 121. The drive modules 121 are electrically coupled to the power module 30.

A number of lenses 122 are mounted on light emitting side of the light emitting diodes 120 for modulating the light emitted therefrom. A lens fixture 123 is mounted on each of the lamps 12 with screws 100 for fixing the lenses 122 on the light emitting diodes 120.

The cover 14 includes a transparent part 140 and a flange 142. A number of slits 144 is defined in the flange 142. A shape of the fixture frame 15 is corresponding to that of the flange 142 of the cover 14. A number of though holes 150 is defined in the fixture frame 15. The cover 14 and the fixture frame 15 are mounted on the mounting surface 110a with the screws. The sealing ring 13 is positioned between the cover 14 and the mounting surface 110a of the mounting plate 110.

A number of first heat dissipation pins 112 and a number of second heat dissipation pins 113 are defined on the heat dissipation surface 110b. The locations of the first heat dissipation pins 112 are corresponding to those of the light emitting diodes 120 for the dissipation of heat generated by the light emitting diode 120. The second heat dissipation pins 113 are defined around the first heat dissipation pins and are configured for improving the air convection in the illumination device 1. A wiring hole 114 is defined in the mounting plate 110. The waterproof screw 16 is received in the wiring hole 114. Wires from the lamps 12 to the power module 30 are received in the waterproof screw. A number of air holes 1200a are defined in the main base 1200.

The base 20 includes a first connection portion 21 and a second connection portion 22. The first connection portion 21 is sleeved-shaped and is configured for mounting the supporting structure 2. The second connection portion 22 is configured for fixing the light source modules 10. A number of screw holes 210 are defined in the first connection portion 21. The base 20 is configured for mounting on the supporting structure 2 with the screws 100 and the screw holes 210. The second connection portion 22 is planar. The second connection portion 22 is mounted on one side of the first connection portion 21. The second connection portion 22 includes an upper surface 220 and a bottom surface 222. A first groove 2200 is defined in the upper surface 220 of the second connection portion 22 and adjacent to the first connection portion 21. A second groove 2220 is defined in the bottom surface 222 and corresponds to the first groove 2200. A number of position holes 2202 are defined in the flange of the second connection portion 22. The base 20 further includes a second cover 23. The second cover 23 is mounted on an end of the first connection portion 21 with screws 100 for covering an end of a through hole of the first connection portion 21. The through hole accommodates an end of the supporting structure 2.

In assembling, the first protrusion 1200b and the second protrusion 1202a of the connection block 111 are firstly slid in the first groove 2200 and the second groove 2220 until the connection block 111 reaches a predetermined position; then the screws 100 are brought to extend in the position holes 1202b, 2202 to securely connect the base 20 and the light source module 10 together. The power module 30 is mounted above the first heat sink pins 112 and the second heat sink pins 113. In the embodiment, four light source modules 10 are mounted on the base 20. The number of the light source modules 10 can be determined according to specific request, such as size of the illumination device or specific luminance of the illumination device.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An illumination device comprising:
a base comprising a first connection portion and a second connection portion, the first connection portion configured for mounting a supporting structure; and
a plurality of light source modules, each of the light source modules comprising a main plate and a lamp, the lamp mounted on a mounting plate of the main plate, the lamp comprising a plurality of light emitting diodes, a connection block defined on a opposite surface of the mounting plate; and
wherein each connection block of each of the light source modules is fixed to the second connection portion of the base after the connection block is slid on the second connection portion to reach a predetermined position.

2. The illumination device of claim 1, the first connection portion of the base is sleeved-shaped, a plurality of screw holes defined in the first connection portion of the base, the first connection portion of the base configured for mounting on the supporting structure with a plurality of screws and the screw holes of the first connection portion.

3. The illumination device of claim 2, wherein the connection block comprises a main base, a connection portion and a supporting portion, two first protrusions are defined on two opposite sides of the main base, two second protrusions are defined on two opposite sides of the connection portion, each of the two first protrusions faces each second protrusion.

4. The illumination device of claim 3, wherein the second connection portion of the base is planar and comprises an upper surface and a bottom surface, a first groove is defined in the upper surface, a second groove is defined in the bottom surface, the first groove and the second groove are configured for respectively receiving one of the two first protrusions and one of the two second protrusions.

5. The illumination device of claim 4, wherein a plurality of position holes is defined in the connection block, each of light source modules is mounted on the base with a plurality of screws extending through the base and secured into the position holes.

6. The illumination device of claim 1, wherein the lamp further comprises a plurality of lenses and a lens fixture, each of the lenses is mounted on each light emitting diode through the lens fixture.

7. The illumination device of claim 1, wherein a receiving portion is defined in the mounting plate, the lamp is mounted on the receiving portion of the mounting plate.

8. The illumination device of claim 7 further comprising a cover, a sealing ring and a fixture frame, the cover is mounted on the mounting plate through the fixture frame and a plurality of screws, the sealing ring is positioned between the cover and the mounting plate.

9. The illumination device of claim 1 further comprising a power module electrically coupled to the light emitting diodes of the lamp.

10. The illumination device of claim 9 further comprising a waterproof screw, a wiring hole defined in the mounting plate for receiving the waterproof screw, wires from the light emitting diodes to the power module are receiving in the wiring hole.

11. The illumination device of claim 1, wherein a plurality of first heat dissipation pins and a plurality of second heat dissipation pins are defined on the opposite surface of the surface that the lamp is mounted on, locations of the first heat dissipation pins are corresponding to the light emitting diodes of the lamp, the second heat dissipation pins are defined around the first heat dissipation pins.

12. An illumination device comprising:
a base comprising a first connection portion and a second connection portion, the first connection portion configured for mounting a supporting structure; and
a plurality of light source modules;
wherein each of the light source modules is fixed to the second connection portion of the base after each of the light source modules is slid on the base to reach a predetermined position, each of the light source modules comprising a heat dissipation module, the heat dissipation module comprising a plurality of first heat dissipation pins and a plurality of second heat dissipation pins, locations of the first heat dissipation pins are corresponding to the light emitting diodes of each of the light source modules for the dissipation of heat generated by the light emitting diodes, the second heat dissipation pins are defined around the first heat dissipation pins for improving the air convection in the illumination device.
